(19) United States
(12) Patent Application Publication
(10) Pub. No.: US 2015/0271733 A1
(43) Pub. Date: Sep. 24, 2015

(54) METHOD, APPARATUS AND COMPUTER PROGRAM PRODUCT FOR PATH SWITCH IN DEVICE-TO-DEVICE COMMUNICATION

(71) Applicant: NOKIA TECHOLOGIES OY, Espoo (FI)

(72) Inventors: Haitao Li, Beijing (CN); Yang Liu, Beijing (FI); Yixue Lei, Beijing (CN); Zexian Li, Espoo (FI); Juejia Zhou, Beijing (CN)

(21) Appl. No.: 14/437,806

(22) PCT Filed: Nov. 9, 2012
(86) PCT No.: PCT/CN2012/084414

§ 371 Date: Apr. 22, 2015

(51) Int. Cl. H04W 40/12; H04W 24/02

(52) U.S. Cl. CPC H04W 40/12; H04W 24/02

(57) ABSTRACT

Methods, corresponding apparatuses, and computer program products for path switch in the D2D communication are provided. The method comprises receiving, from a network element, a path switch command which is generated when a pair of user equipments in device-to-device communication over a default data path is served by the same base station. The method further comprises switching, based at least in part upon the path switch command, a data path of the pair of user equipments in the device-to-device communication from the default data path to an optimized data path. With the claimed inventions, smooth switching could be realized without degradation to the user experience.

### FIELD OF THE INVENTION

Embodiments of the present invention generally relate to wireless communication techniques including the 3GPP (the 3rd Generation Partnership Project) LTE (Long Term Evolution) technique. More particularly, embodiments of the present invention relate to methods, apparatuses, and computer program products for a path switch in device-to-device (D2D) communication.

### BACKGROUND OF THE INVENTION

Various abbreviations that appear in the specification and/or in the drawing figures are defined as below:

BS Base Station

CN Core Network

DRB Data Radio Bearer

DRSF D2D Registration Server Function

eNB evolved Node B

EPS Enhanced Packet System

GW Gateway

MME Mobility Management Entity

ProSe Proximity Services

P-GW Packet Data Network Gateway

RRC Radio Resource Control

RAN Radio Access Network

SDU Service Data Unit

S-GW Serving Gateway

S-TMSI S-Temporary Mobile Subscriber Identity

UE User Equipment

The following description of background art may include insights, discoveries, understandings or disclosures, or associations together with disclosures not known to the relevant art prior to the present invention but provided by the present invention. Some such contributions of the present invention may be specifically pointed out below, while other such contributions of the present invention will be apparent from their context

Currently, 3GPP TR22.803 V0.5.0 (2012-08), “Technical Specification Group SA, Feasibility Study for Proximity Services (ProSe) (Release 12),” defines a default data path and an optimized data path for ProSe communication (e.g., D2D communication), wherein communication over the default data path involves the data path of backhaul and CN side (e.g., S-GW and P-GW) and a RAN side (e.g., eNB) and communication over the optimized data path offloads the backhaul and CN data and only involves the eNB's air-interface data path to the UE. In other words, the D2D communication over the optimized data path is only limited to the case where a single eNB is controlling the D2D communication between two D2D capable UEs, which means UEs that are served by different eNBs cannot establish the optimized data path but the default data path for the D2D communication.

Different from a Wi-Fi technique which naturally enables ad hoc mode communication, incorporating the D2D capability into cellular-based LTE systems appears to confront more technical challenges. For instance, the optimized data path and default data path modes added to the LTE networks would bring about new issues of how to achieve efficient triggers for mode switching, which is deemed important from both user and operator's perspectives in terms of a better user experience, better network offloading efficiency and service continuity, and of how to manage radio bearers during the D2D communication under the LTE systems.

### SUMMARY OF THE INVENTION

The following presents a simplified summary of the present invention in order to provide a basic understanding of some aspects of the present invention. It should be noted that this summary is not an extensive overview of the present invention and that it is not intended to identify key/critical elements of the present invention or to delineate the scope of the present invention. Its sole purpose is to present some concepts of the present invention in a simplified form as a prelude to the more detailed description that is presented later.

In order to mitigate or alleviate at least one of the potential problems as discussed before, embodiments of the present invention provide an efficient way of performing data path switching between the default data path and the optimized data path such that the data paths of D2D capable UEs can be flexibly and smoothly switched and radio resources could be efficiently utilized.

One embodiment of the present invention provides a method. The method comprises receiving, from a network element, a path switch command which is generated when a pair of UEs in D2D communication over a default data path is served by the same BS. The method also comprises switching, based at least in part upon the path switch command, a data path of the pair of UEs in the D2D communication from the default data path to an optimized data path.

Another embodiment of the present invention provides a method. The method comprises generating a path switch command when a pair of UEs in D2D communication over a default data path is served by the same BS. The method further comprises sending to a network element the path switch command for switching a data path of the pair of UEs in the D2D communication from the default data path to an optimized data path.

One embodiment of the present invention provides an apparatus. The apparatus comprises means for receiving, from a network element, a path switch command which is generated when a pair of UEs in D2D communication over a default data path is served by the same BS. The apparatus also comprises means for switching, based at least in part upon the path switch command, a data path of the pair of UEs in the D2D communication from the default data path to an optimized data path.

A further embodiment of the present invention provides an apparatus. The apparatus comprises means for generating a path switch command when a pair of UEs in D2D communication over a default data path is served by the same BS. The apparatus also comprises means for sending to a network element the path switch command for switching a data path of the pair of UEs in the D2D communication from the default data path to an optimized data path.

A further embodiment of the present invention provides an apparatus. The apparatus comprises at least one processor and at least one memory including computer program instructions. The at least one memory and computer program instructions are configured to, with the at least one processor, cause the apparatus at least to receive, from a network element, a path switch command which is generated when a pair of UEs in D2D communication over a default data path is served by the same BS. The at least one memory and computer program instructions are also configured to, with the at least one processor, cause the apparatus at least to switch, based at least in part upon the path switch command, a data path of the pair of UEs in the D2D communication from the default data path to an optimized data path.

An additional embodiment of the present invention provides an apparatus. The apparatus comprises at least one processor and at least one memory including computer program instructions. The at least one memory and computer program instructions are configured to, with the at least one processor, cause the apparatus at least to generate a path switch command when a pair of UEs in D2D communication over a default data path is served by the same BS. The at least one memory and computer program instructions are also configured to, with the at least one processor, cause the apparatus at least to send to a network element the path switch command for switching a data path of the pair of UEs in the D2D communication from the default data path to an optimized data path.

One embodiment of the present invention provides a computer program product, comprising at least one computer readable storage medium having a computer readable program code portion stored thereon. The computer readable program code portion comprises program code instructions for receiving, from a network element, a path switch command which is generated when a pair of UEs in D2D communication over a default data path is served by the same BS. The computer readable program code portion also comprises program code instructions for switching, based at least in part upon the path switch command, a data path of the pair of UEs in the D2D communication from the default data path to an optimized data path.

Another embodiment of the present invention provides a computer program product, comprising at least one computer readable storage medium having a computer readable program code portion stored thereon. The computer readable program code portion comprises program code instructions for generating a path switch command when a pair of UEs in D2D communication over a default data path is served by the same BS. The computer readable program code portion also comprises program code instructions for sending to a network element the path switch command for switching a data path of the pair of UEs in the D2D communication from the default data path to an optimized data path.

With the above embodiments of the present invention, by taking into account the serving BS or its changes for the pair of UEs in the D2D communication, efficient triggers for D2D mode switching to the optimized path can be obtained. Further, by switching the data path of the pair of UEs in the D2D communication from the default data path to the optimized data path, backhaul and CN traffic load for operators can be alleviated. In addition, smooth switching as achieved by the embodiments of the present invention brings no performance degradation to the user experience.

### BRIEF DESCRIPTION OF THE DRAWINGS

The embodiments of the present invention that are presented in the sense of examples and their advantages are explained in greater detail below with reference to the accompanying drawings, in which:

FIG. 1 illustrates an exemplary and simplified network architecture in which the embodiments of the present invention may be practiced;

FIG. 2 is a flow diagram schematically illustrating a method for a path switch in D2D communication from an MME's prospective according to an embodiment of the present invention;

FIG. 3 is a flow diagram schematically illustrating another method for a path switch from a DRSF server's prospective according to an embodiment of the present invention;

FIG. 4 is a messaging diagram schematically illustrating the switching of a data path of a pair of UEs in the D2D communication from the default data path to the optimized data path according to embodiments of the present invention;

FIG. 5 is a messaging diagram schematically illustrating the switching of a data path of a pair of UEs in the D2D communication from the optimized data path to the default data path according to embodiments of the present invention; and

FIG. 6 is a simplified schematic block diagram illustrating apparatuses according to the embodiments of the present invention.

### DETAILED DESCRIPTION OF EMBODIMENTS

The exemplary embodiments of the present invention provide methods and apparatuses for switching the data path (mode) of the pair of UEs in the D2D communication between the default data path (mode) and the optimized data path (mode) and additionally configuring corresponding D2D radio bearers in the air interface. In one embodiment, switching the data path from the default data path to the optimized data path is performed on the condition that the pair of the D2D capable UEs is served by the same BS, e.g., the same eNB. In another embodiment, switching the data path from the optimized data path to the default data path relies upon the fact that one of the pair of the D2D capable UEs is about to move outside the cell range of the same BS that has been serving the pair of UEs.

Hereinafter, exemplary of the present invention will be described in detail with reference to the accompanying drawings.

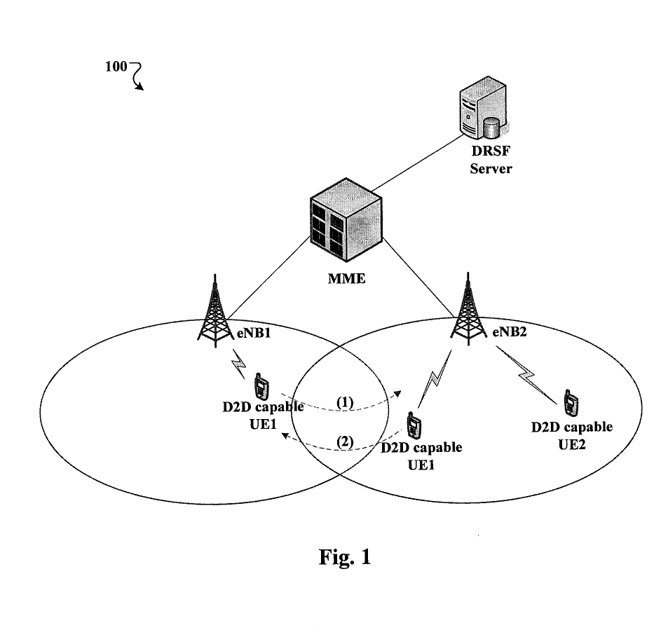

FIG. 1 illustrates an exemplary and simplified network architecture 100 in which the embodiments of the present invention may be practiced. As illustrated in FIG. 1, the network architecture 100 includes an eNB1, an eNB2, a pair of D2D capable UEs (UE1 and UE2) in the D2D communication via the eNB 1 or eNB2, an MME connecting with the eNB1 and eNB2 and a DRSF server in connection with the MME. As seen from the drawing, the UE1 may be in the D2D communication with the UE2 via a data path constituted by the eNB2, MME, and eNB1, thereby the pair of UEs entering into the default data path mode. Further, the UE1 may move out of the cell range of the eNB1 and enter into the cell range of the eNB2 and thus it would be served by the eNB2 after e.g., a handover procedure. Then, the UE2 would communicate with the UE1 only via the same eNB2 with potential offloaded traffic from the backhaul and the CN, e.g. S-GW and P-GW, thereby the pair of UEs entering into the optimized data path mode from the previous default data path mode.

To achieve data path switching as above, the embodiments of the present invention introduce the DRSF server which has been employed in some existing D2D communication solutions and is in charge of registration, authentication, identification of the D2D UEs, and charging for the D2D users. Below are brief discussions about how the DRSF server would assist in the data path switching.

In a scenario in which the UE1 and UE2 are in communication with each other over the default data path and over time, the UE1 may leave the cell range of the eNB1 and enter into the cell range of the eNB2, once a handover procedure, as illustrated by a one-way arrow (1), has been completed between the eNB1 and eNB2, the MME will notify the DRSF server of the UE1's new serving eNB (i.e., eNB2)/cell information. Then, the DRSF server may check potential UE pairing information, which has been collected when the D2D UEs registered with the DRSF server, and may find out this pair of UEs are served by the same eNB/cell (i.e., eNB2). On this basis, the DRSF server may send an indication to the MME to trigger backhaul and CN offloading process and perform mode switching from the ongoing default path mode to the optimized data path mode.

In a scenario in which the data path would be switched from the optimized data path to the default data path, the MME should maintain the D2D bearer related information (e.g., QoS parameters) after the D2D communication has been switched from the default path to the optimized data path. This D2D bearer related information could be obtained by the eNB keeping reporting to the MME in case the D2D bearer setup takes place between D2D pairs without MME involvement. When the condition for maintaining the optimized data path cannot be met any more, for example, due to the situation that the one of the pair of UEs becomes increasingly distant from the same eNB and thus the same eNB is no longer appropriate for serving the UE at issue, the same eNB would inform the MME of this situation during a handover preparation. Having been informed of this situation, the MME may indicate this to the DRSF server and then the DRSF server may send a mode switch command to the MME to resume the EPS bearer path according to previously stored D2D bearer related information. In other words, when the UE1 is about to leave the cell range of the eNB2 and thus the optimized data path may no longer be good enough for the D2D communication, the DRSF server may indicate the MME to trigger the mode switching such that the D2D traffic could be on-loaded back to the backhaul and CN side. After the data path has been switched from the optimized data path to the default data path, the UE1 would be handed over from the eNB2 to the eNB1. In this manner, the mode switching would have been completed prior to the handover, resulting in good service continuity.

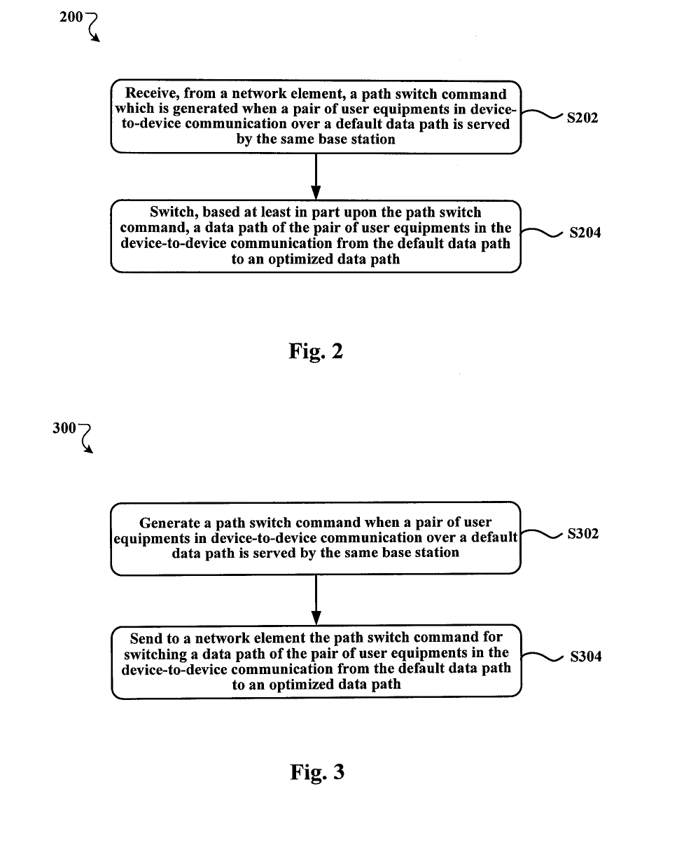

FIG. 2 is a flow diagram schematically illustrating a method 200 for a path switch in D2D communication from an MME's prospective according to an embodiment of the present invention. As illustrated in FIG. 2, at step S202, the method 200 may receive, from a network element (e.g., a DRSF server), a path switch command which is generated when a pair of UEs in D2D communication over a default data path (e.g., the UE1 and UE2 being served by respective eNB1 and eNB2 in FIG. 1) is served by the same BS (e.g., eNB2 in FIG. 1). Then, at step S204, the method 200 may switch, based at least in part upon the path switch command, a data path of the pair of UEs in the D2D communication from the default data path to an optimized data path.

Although not shown in FIG. 2, in one embodiment, the method 200 further comprises sending updated cell information of one of the pair of UEs in the D2D communication to the network element, wherein the updated cell information is used to determine that the pair of UEs in the D2D communication is served by the same BS. The updated cell information may relate to the same BS to which the one of the pair of UEs has been handed over.

In another embodiment, the method 200 comprises receiving, from the network element, another path switch command which is generated when one of the pair of UEs in the D2D communication over the optimized data path is about to move out of a cell range of the same BS and switching, based at least in part upon the other path switch command, the data path of the pair of UEs in the D2D communication from the optimized data path to the default data path.

In yet another embodiment, the method 200 further comprises sending updated cell information of the one of the pair of UEs in the D2D communication to the network element, wherein the updated cell information is used to determine that the one of the pair of UEs is about to move out of the cell range of the same BS. The updated cell information indicates that the one of the pair of UEs is about to move out of the cell range of the same BS.

Owing to the method 200 and its multiple variants and extensions as discussed in the above embodiments, the data path mode switching between the default data path and the optimized data path can be flexibly and smoothly completed. Meanwhile, good service continuity could also be achieved.

FIG. 3 is a flow diagram schematically illustrating another method 300 for a path switch from a DRSF server's prospective according to an embodiment of the present invention. As illustrated in FIG. 3, at step S302, the method 300 generates a path switch command when a pair of UEs in D2D communication over a default data path (e.g., the UE1 and UE2 being served by respective eNB 1 and eNB 2 in FIG. 1) is served by the same BS (e.g., eNB2 in FIG. 1). At step S304, the method 300 sends to a network element (e.g., the MME in FIG. 1) the path switch command for switching a data path of the pair of UEs in the D2D communication from the default data path to an optimized data path.

Although not shown in FIG. 3, in one embodiment, the method 300 further comprises receiving, from the network element, updated cell information of one of the pair of UEs in the D2D communication, wherein the updated cell information is used to determine that the pair of UEs in the D2D communication is served by the same BS. The updated cell information may relate to the same base station to which the one of the pair of UEs has been handed over.

In an embodiment, the method 300 further comprises generating another path switch command when one of the pair of UEs in the D2D communication over the optimized data path is about to move out of a cell range of the same BS and sending to the network element the other path switch command for switching a data path of the pair of UEs in the D2D communication from the optimized data path to the default data path.

In yet another embodiment, the method 300 further comprises receiving, from the network element, updated cell information of the one of the pair of UEs in the D2D communication, wherein the updated cell information is used to determine that the one of the pair of UEs is about to move out of the cell range of the same BS. The updated cell information may indicate that the one of the pair of UEs is about to move out of the cell range of the same BS.

Similar to the method 200, the method 300 and its multiple variants and extension as described above enable smooth switching between the default data path and the optimized data path and thereby service continuity can be well maintained.

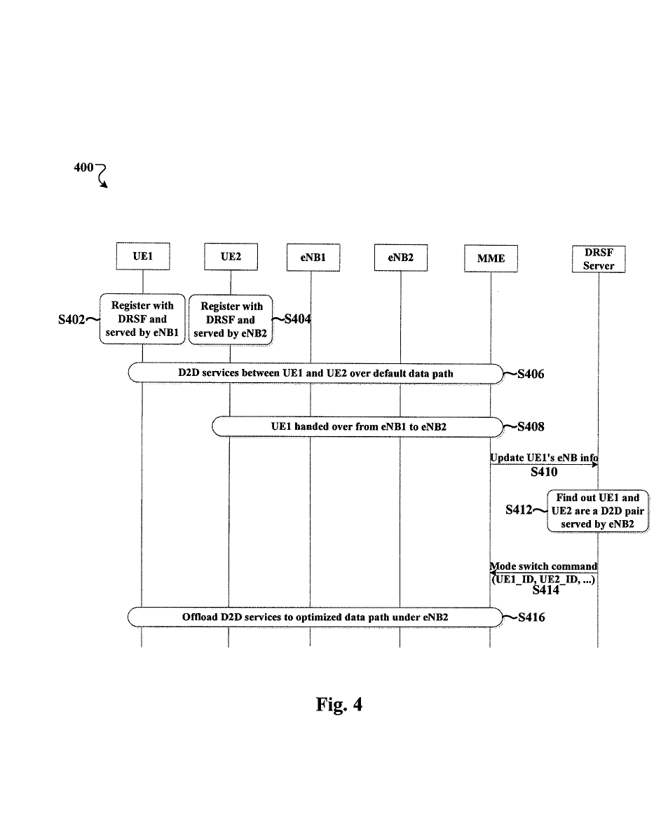

FIG. 4 is a messaging diagram schematically illustrating the switching 400 of a data path of a pair of UEs in the D2D communication from the default data path to the optimized data path according to embodiments of the present invention, under the network architecture 100 as shown in FIG. 1. As shown in FIG. 4, at steps S402 and S404, the UE1 served by the eNB 1 and UE2 served by the eNB 2 have their respective D2D capabilities enabled and register with or attach to the DRSF server. For D2D capable UEs, attaching to the DRSF server may be helpful for network control over the upcoming D2D communication. During the DRSF server registration or attach procedure, a D2D capable UE can provide information including but not limited to a UE ID, a D2D user ID, a D2D service type, a friend list, and etc. This information can assist the network in identifying potential D2D pairs and then triggering D2D communication with the proper mode.

Then, at step S406, due to different serving eNBs, the D2D communication between the UE1 and UE2 commences over the default data path. Suppose that the user of the UE1 keeps moving towards eNB 2 during the D2D communication, and thus at step S408, the UE1 is handed over from the eNB1 to the eNB2, as is depicted in the one-way arrow (1) in FIG. 1. Due to mobility procedures as defined by the 3GPP specification for the connected mode UE, the MME is always aware of the connected mode UE's serving eNB/cell information. To facilitate the mode switching to the optimized data path, the MME, at step S410, sends the UE1's new serving eNB/cell information (i.e., information in regards to eNB1) to the DRSF server. As above mentioned, the DRSF server has already stored UE's full D2D-related information and thus is able to determine or find out, at step S412, that two paired UE1 and UE2 are currently being served by the same eNB/cell (i.e. eNB2). Then, at Step S414, the DRSF server sends a mode switch command, which may include the identifiers of the UE1 and UE2 and other relevant information, to the MME.

Upon receiving the mode switch command from the DRSF server, the MME will perform, at step S416, backhaul and CN offloading for those D2D services by saving the backhaul and CN paths and only leaving D2D radio bearers in the air interface. From an air interface perspective, these D2D radio bearers have nothing different from the normal EPS radio bearers in terms of radio resources consumption. However, both the UE and eNB should be aware that these are D2D radio bearers instead of EPS radio bearers since the UE should tell how to encapsulate D2D data or EPS data to which radio bearers. Further, the eNB needs to differentiate the D2D radio bearers and the EPS radio bearers because it needs to decide whether to forward this uplink data to S-GW or directly to the other paired UE. To realize such differentiation, the embodiments of the present invention propose explicitly indicating in the DRB configuration whether this radio bearer is for D2D services or EPS services during the DRB setup phase. For example, IEs with extension fields (bolded) for the above differentiation are illustrated as below:

DRB-ToAddMod ::= SEQUENCE {

| | | | | |
|---|---|---|---|---|
| | eps-BearerIdentity | INTEGER (0..15) | OPTIONAL, | -- Cond DRB-Setup |
| | drb-Identity | DRB-Identity | | |
| | pdcp-Config | PDCP-Config | OPTIONAL, | -- Cond PDCP |
| | rlc-Config | RLC-Config | OPTIONAL, | -- Cond Setup |
| | logicalChannelIdentity | INTEGER (3..10) | OPTIONAL, | -- Cond DRB-Setup |
| | logicalChannelConfig | LogicalChannelConfig | OPTIONAL, | -- Cond Setup |
| | ... | | | |
| | drb-type | ENUMERATED (EPS, D2D) | OPTIONAL, | -- Cond DRB-Setup |
| } | | | | |

Although not depicted in FIG. 4, it should be noted that the MME may not report each UE's new eNB/cell information to the DRSF server so as to avoid a huge amount of signaling overhead. To this end, the MME may selectively report those D2D-capable UEs that previously reported their respective D2D capability information to the MME.

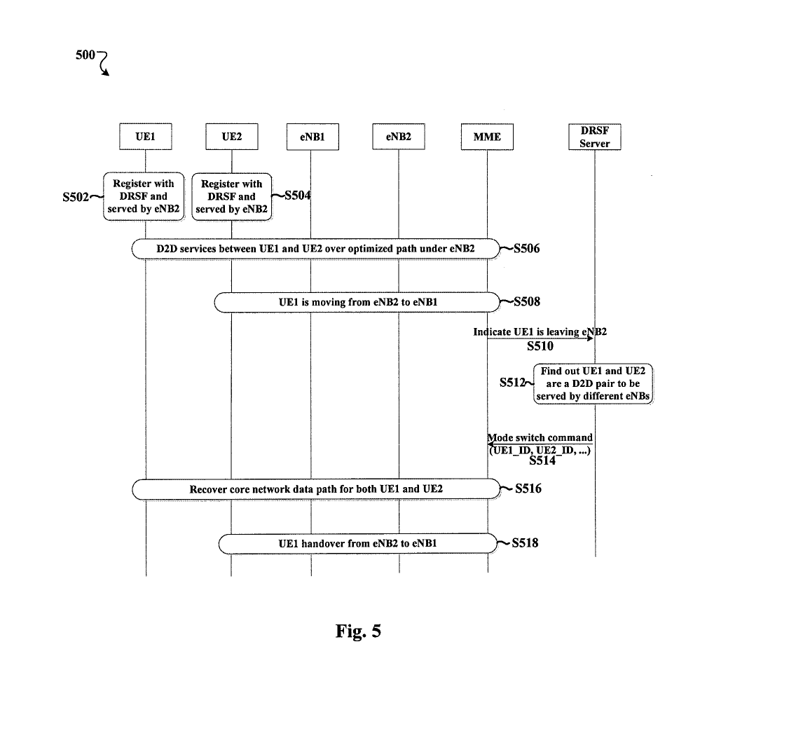

FIG. 5 is a messaging diagram schematically illustrating the switching 500 of a data path of a pair of UEs in the D2D communication from the optimized data path to the default data path according to embodiments of the present invention, under the network architecture 100 as shown in FIG. 1. As shown in FIG. 5 and similar to FIG. 4, the UE1 and UE2 served by the same eNB2 register with the DRSF server at steps S502 and S504, respectively. Thereafter, D2D services between the UE1 and UE2 have been established and performed over the optimized data path under the single serving eNB2 at step S506.

Suppose that one of the paired D2D UEs, i.e., UE1, is moving from the eNB2 towards the eNB1 at step S508. After the UE1's mobility triggers measurement reporting to the eNB2, the eNB2 realizes the UE1 has ongoing D2D services and prepares a handover procedure to the eNB 1 via the MME. Upon reception of a handover request from the eNB2, the MME will indicate, at step S510, to the DRSF server that the UE1 is about to move to the eNB1, i.e., leaving the cell range of the eNB2. Then, the DRSF server checks and finds out, at step S512, that the UE1 and UE2 are a pair of D2D UEs to be served by different eNBs based upon the pairing information related to the reported UE2. Upon this finding, the DRSF server sends, at step S514, a mode switch command including but not limited to the identifiers of the UE1 and UE2 to the MME. As per the mode switch command, the MME recovers, at step S516, respective backhaul and core network data paths for UE1 and UE2. In other words, the data path of the UE1 and UE2 is switched from the optimized data path to the default data path. Afterwards, at step S518, the UE1 may be handed over from the eNB2 to the eNB1, as is depicted in a one-way arrow (2) in FIG. 1.

The foregoing has discussed the embodiments of the present invention in one possible step order, it should be noted that this order is merely illustrative of the present invention. A person skilled in the art can understand that the embodiments of the present invention can be carried out in any suitable orders.

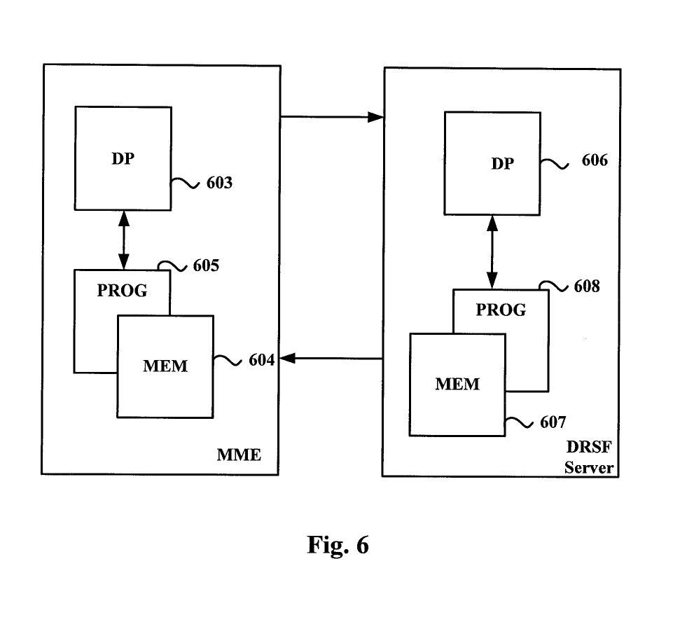

FIG. 6 is a simplified schematic block diagram illustrating apparatuses according to the embodiments of the present invention. As illustrated in FIG. 6, an MME may, among other things, include at least one (data) processor 603 and at least one memory 604 including computer program instructions 605. The at least one memory 604 and computer program instructions 605 are configured to, with the at least one processor 603, cause the MME at least to perform the steps as recited in the method 200 and depicted in FIG. 4. Likewise, the DRSF server may, among other things, include at least one (data) processor 606 and at least one memory 607 including computer program instructions 608. The at least one memory 607 and computer program instructions 608 are configured to, with the at least one processor 606, cause the DRSF server at least to perform the steps as recited in the method 300 and depicted in FIG. 5. In other words, the embodiments of the present invention can be implemented by network elements, such as the MME and the DRSF server, in an interactive manner, as depicted by the two arrows in FIG. 6.

The MEMs 604 and 607 may be of any type suitable to the local technical environment and may be implemented using any suitable data storage technology, such as semiconductor based memory devices, magnetic memory devices and systems, optical memory devices and systems, fixed memory and removable memory, as non-limiting examples. While only one MEM is shown in the MME or the DRSF server, there may be several physically distinct memory units in the MME or DRSF server.

The processors 603 and 606 may be of any type suitable to the local technical environment, and may include one or more of general purpose computers, special purpose computers, microprocessors, DSPs and processors based on multicore processor architecture, as non limiting examples. Either or both of the MME and the DRSF server may have multiple processors, such as for example an application specific integrated circuit chip that is slaved in time to a clock which synchronizes the main processor.

The techniques described herein may be implemented by various means so that an apparatus implementing one or more functions of a corresponding entity described with an embodiment comprises not only prior art means, but also means for implementing the one or more functions of a corresponding apparatus described with an embodiment and it may comprise separate means for each separate function, or means may be configured to perform two or more functions. For example, these techniques may be implemented in hardware (one or more apparatuses), firmware (one or more apparatuses), software (one or more modules or virtual means), or combinations thereof. For a firmware or software, implementation can be through modules (e.g., procedures, functions, and so on) that perform the functions described herein. The software codes may be stored in any suitable, processor/computer-readable data storage medium(s) or memory unit(s) or article(s) of manufacture and executed by one or more processors/computers. The data storage medium or the memory unit may be implemented within the processor/computer or external to the processor/computer, in which case it can be communicatively coupled to the processor/computer via various means as is known in the art.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

1-24. (canceled)

25. A method, comprising:
receiving, from a network element, a path switch command which is generated when a pair of user equipments in device-to-device communication over a default data path is served by the same base station; and
switching, based at least in part upon the path switch command, a data path of the pair of user equipments in the device-to-device communication from the default data path to an optimized data path.

26. The method as recited in claim 25, further comprising:
sending updated cell information of one of the pair of user equipments in the device-to-device communication to the network element, wherein the updated cell information is used to determine that the pair of user equipments in the device-to-device communication is served by the same base station.

27. The method as recited in claim 26, wherein the updated cell information relates to the same base station to which the one of the pair of user equipments has been handed over.

28. The method as recited in claim 25, further comprising:
receiving, from the network element, another path switch command which is generated when one of the pair of user equipments in the device-to-device communication over the optimized data path is about to move out of a cell range of the same base station; and
switching, based at least in part upon the other path switch command, the data path of the pair of user equipments in the device-to-device communication from the optimized data path to the default data path.

29. The method as recited in claim 28, further comprising:
sending updated cell information of the one of the pair of user equipments in the device-to-device communication to the network element, wherein the updated cell information is used to determine that the one of the pair of user equipments is about to move out of the cell range of the same base station.

30. An apparatus, comprising:
at least one processor; and
at least one memory including compute program instructions,
wherein the at least one memory and computer program instructions are configured to, with the at least one processor, cause the apparatus at least to:
receive, from a network element, a path switch command which is generated when a pair of user equipments in device-to-device communication over a default data path is served by the same base station; and
switch, based at least in part upon the path switch command, a data path of the pair of user equipments in the device-to-device communication from the default data path to an optimized data path.

31. The apparatus as recited in claim 30, wherein the apparatus is further caused to send updated cell information of one of the pair of user equipments in the device-to-device communication to the network element, wherein the updated cell information is used to determine that the pair of user equipments in the device-to-device communication is served by the same base station.

32. The apparatus as recited in claim 31, wherein the updated cell information relates to the same base station to which the one of the pair of user equipments has been handed over.

33. The apparatus as recited in claim 30, wherein the apparatus is further caused to:
receive, from the network element, another path switch command which is generated when one of the pair of user equipments in the device-to-device communication over the optimized data path is about to move out of a cell range of the same base station; and
switch, based at least in part upon the other path switch command, the data path of the pair of user equipments in the device-to-device communication from the optimized data path to the default data path.

34. The apparatus as recited in claim 30, wherein the apparatus is further caused to send updated cell information of the one of the pair of user equipments in the device-to-device communication to the network element, wherein the updated cell information is used to determine that the one of the pair of user equipments is about to move out of the cell range of the same base station.

35. An apparatus, comprising:
at least one processor; and
at least one memory including compute program instructions,
wherein the at least one memory and computer program instructions are configured to, with the at least one processor, cause the apparatus at least to:
generate a path switch command when a pair of user equipments in device-to-device communication over a default data path is served by the same base station; and
send to a network element the path switch command for switching a data path of the pair of user equipments in the device-to-device communication from the default data path to an optimized data path.

36. The apparatus as recited in claim 35, wherein the apparatus is further caused to receive, from the network element, updated cell information of one of the pair of user equipments in the device-to-device communication, wherein the updated cell information is used to determine that the pair of user equipments in the device-to-device communication is served by the same base station.

37. The apparatus as recited in claim 36, wherein the updated cell information relates to the same base station to which the one of the pair of user equipments has been handed over.

38. The apparatus as recited in claim 35, wherein the apparatus is further caused to:
generate another path switch command when one of the pair of user equipments in the device-to-device communication over the optimized data path is about to move out of a cell range of the same base station; and
send to the network element the other path switch command for switching a data path of the pair of user equipments in the device-to-device communication from the optimized data path to the default data path.

39. The apparatus as recited in claim 38, wherein the apparatus is further caused to receive, from the network element, updated cell information of the one of the pair of user equipments in the device-to-device communication, wherein the updated cell information is used to determine that the one of the pair of user equipments is about to move out of the cell range of the same base station.
